(19) United States
(12) Patent Application Publication
(10) Pub. No.: US 2018/0028406 A1
(43) Pub. Date: Feb. 1, 2018

(54) Secure Controlled Substance Pill Dispensing Device

(71) Applicant: Jim Patton, Edmond, OK (US)

(72) Inventors: Jim Patton, Edmond, OK (US); John Barr, Mooresville, NC (US); Alexander Werbickas, Marlton, NJ (US); Patrick Bailey, Charlotte, NC (US); Jeremy Losaw, Charlotte, NC (US); Juan Carlos Perez, Charlotte, NC (US); Raeshon McNeil, Charlotte, NC (US); Cory Hymel, Charlotte, NC (US)

(21) Appl. No.: 15/225,564

(22) Filed: Aug. 1, 2016

(51) Int. Cl. A61J 7/00; A61J 7/04; A61J 7/02

(52) U.S. Cl. CPC A61J 7/0076; A61J 7/0069; A61J 7/02; A61J 7/04; A61J 2205/60; A61J 2200/42

(57) ABSTRACT

A pill dispensing device includes a lid with an RFID reader and a container that engages that lid. The container includes a hopper that is configured to hold a plurality of pills and a tray that is connect that hopper. The container can dispense a pill from the hopper into the tray when an authorized RFID rob is read by the RFID reader. The pill dispensing device may include a code entry mechanism on the side of the container. The code entry mechanism activates or deactivates a lock. The lock is capable of securing the lid to the container. The pills are dispensed through the pill dispensing device when certain parameters are met. If the device it tampered with, the pills may be rendered unusable by a tamper resistance mechanism.

### RELATED APPLICATIONS

This application is related to and claims the benefit of United States Patent Application No. 2014/704,475, filed May 5, 2015, and United States Patent Application No. 2014/704,570, filed May 5, 2015, both of which are hereby incorporated by reference.

### FIELD OF THE INVENTION

The present invention generally relates to the field of medication packaging and particularly to the dispensing of pills.

### BACKGROUND OF THE INVENTION

The health industry is faced with a multibillion dollar problem of prescription controlled drug abuse. Patients often either inadvertently or intentionally take their medication too frequently or outside the guidance of their treating physician. This problem is exacerbated when unauthorized persons attempt to utilize pills or other prescribed medication from an authorized patient's pill supply. Accordingly, there is a need for a secure pill dispensing device that will ensure that patients do not take their medication more frequently than prescribed and that unauthorized persons are unable to access the medication.

### SUMMARY OF THE INVENTION

A pill dispensing device preferably includes a container and a lid. The container preferably includes a first cylinder, a second cylinder, a bottom, a top ring, a dispensing assembly and a tamper resistance mechanism. The first and second cylinders connect with the bottom of the container, and thereby form a space containing a conductive solution. Any tampering with the device will likely result in a rupture to that space, such that the conductive solution will escape. Alternatively, the conductive solution could be replaced with other substances that can be configured to conduct electricity. Such substances are configured such that any disruption to the integrity of the substance will result in a detectable change in the electrical current. The dispensing assembly preferably includes a hopper, a first trap door, a first chute, a first sensor, a second trap door, a second chute, a second sensor, and a tray. The hopper is configured to accept a plurality of pills, which can then be dispensed through the first chute and the second chute into the tray. The lid engages the container's top ring and preferably includes an RFID reader and a display. The processing unit monitors the conductive solution (or other conductive substance) to ensure that the pill dispensing device has not been tampered with, and when necessary, activates the tamper resistance mechanism to render the plurality of pills unusable.

A preferred second embodiment of the pill dispensing device includes alternative lid and container. The lid engages a top portion of the container. The container includes a hopper assembly and a dispensing assembly. The hopper assembly includes a hopper, a hopper carousel, a carousel shaft, and a tamper resistance mechanism. The hopper carousel is attached to the hopper shaft. The hopper shaft is engaged by a carousel, which functions to rotate the hopper carousel. The tamper resistance mechanism, which includes tamper resistance fluid and jets, is positioned within the hopper. The tamper resistance fluid renders the pills unusable when it is dispensed from the through the jets. The dispensing assembly includes a first dispensing assembly subassembly, a second dispensing assembly subassembly, a third dispensing assembly subassembly, a fourth dispensing assembly subassembly, and a plate driving assembly. The first dispensing assembly subassembly includes a first plate that has a first release, a first chute funnel, a hopper escape slide, and a first chute. The second dispensing subassembly includes a second plate that has a second release, a second chute, a second chute funnel, and a first sensor. The third dispensing subassembly includes a third plate that has a third release, a third chute, a third chute funnel, and a second sensor. The fourth dispensing subassembly includes a fourth plate that has a fourth release, a fourth chute, and a third sensor. The plate driving assembly includes a dispensing assembly motor, a dispensing assembly motor shaft, a first gear, a second gear, a third gear, and a fourth gear. The container attaches to tray, which has a window. The device is capable of releasing pills upon certain parameters being met, and rendering pills unusable if the device is tampered with.

### BRIEF DESCRIPTION OF THE DRAWINGS

FIG. 1 is a side cross-sectional view of the secure controlled substance pill dispenser.

FIG. 2 is a top view of the lid of the secure controlled substance pill dispenser.

FIG. 3 is a top cross-sectional view of the secure controlled substance pill dispenser container and lid.

FIG. 4 is a schematic diagram of the components of the processing module.

FIG. 5 is a side perspective view of an alternative embodiment of a pill dispensing device.

FIG. 6 is a top view of the lid of the alternative embodiment of the pill dispensing device.

FIG. 7 is a side cross sectional view of the alternative embodiment of the pill dispensing device.

FIG. 8 is a perspective view of an alternative embodiment of a hopper.

FIG. 9 is a side view of the alternative embodiment of the hopper.

### DETAILED DESCRIPTION OF THE PREFERRED EMBODIMENTS

To remedy the issues present in the health industry related to the misuse of pills, two embodiments of a secure pill dispensing device 10, 410 are disclosed below.

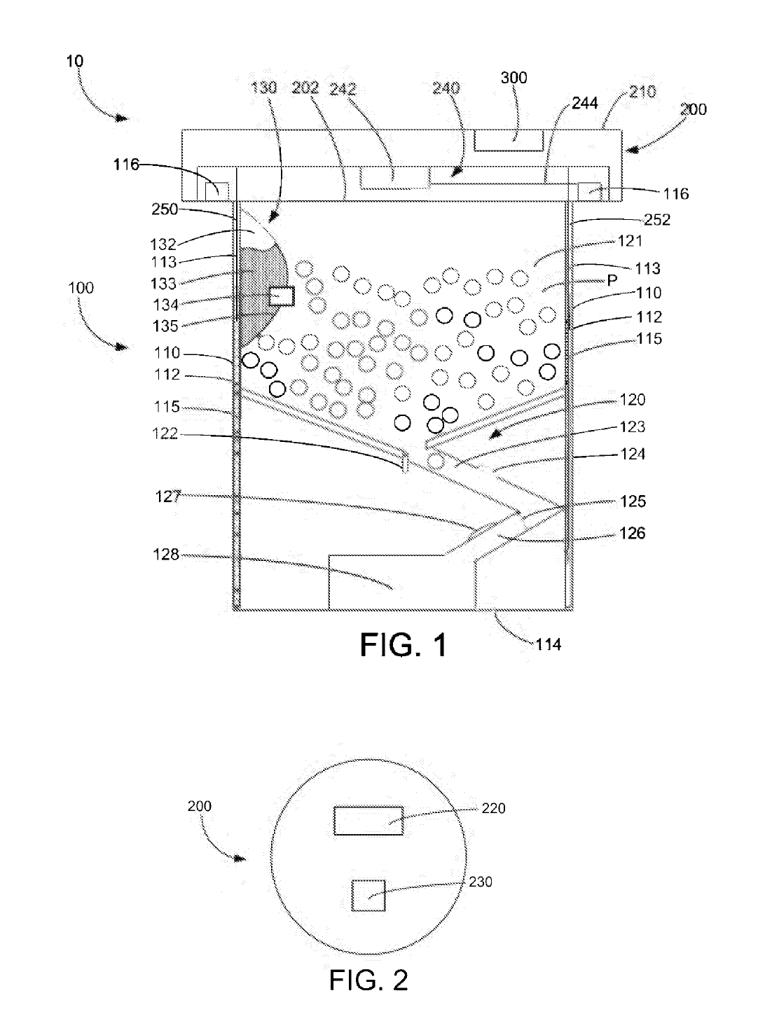

In accordance with the first embodiment of the present invention, FIG. 1 shows a cross-sectional side view of a pill dispensing device 10. The pill dispensing device 10 includes a container 100, a lid 200, and a processing unit 300. As shown, the container 100 includes a top ring 116 that engages the lid 200. In the first embodiment, the processing unit 300 is displaced within a recess in the lid 200, but it will be understood that numerous placements of the processing unit 300 are possible without any restriction in the utility of the pill dispensing device 10.

In the first embodiment, the container 100 is preferably cylindrical and includes a first cylinder 110, a second cylinder 112, a bottom 114, a top ring 116, a dispensing mechanism 120 and a tamper resistance mechanism 130. The first cylinder 110 and second cylinder 112 are formed so that the diameter of the first cylinder 110 is greater than the diameter of the second cylinder 112. Both the first cylinder 110 and second cylinder 120 engage the bottom 114. It is understood that the positioning of the first cylinder 110 and the second cylinder 112 forms a space 113 between the first cylinder 110 and second cylinder 112. This space 113 is filled with a conductive liquid 115 capable of conducting an electric current. The space 113 may otherwise be filled with a material capable of producing electric current, such as wiring, a pad, foam, or a screen. The material capable of producing electric current may be attached to the inside of the container 100 by an adhesive, instead of occupying the space 113. It will be understood in such embodiments that the second cylinder 112 is optional.

The dispensing assembly 120 is positioned within the second cylinder 112 of the container 100, and includes a hopper 121, a first trap door 122, a first chute 123, a first sensor 124 a second trap door 125, a second chute 126, a second sensor 127 and a tray 128. The hopper 121 is configured to hold pills (pills are marked as P in FIGS. 1, 7, and 9). The first trap door 122 engages the hopper 121 in a manner that permits the first trap door 122 to selectively open and close. Notably, FIG. 1 depicts the first trap door 122 in an open position. The first trap door 122 also engages with the first chute 123 such that when the first trap door is open, pills can move from the hopper 121 into the first chute 123. The first sensor 124 is positioned alongside the first chute 123 so that it can detect the presence of a pill in the first chute 123. The second trap door 125 is positioned between the first chute 123 and the second chute 126. The second trap door 125 can selectively be in an open or closed position. In a closed position, the second trap door 125 prevents pills from moving from the first chute 123 to the second chute 126. Notably, in FIG. 1, the second trap door 125 is depicted in a closed position. The second sensor 127 is positioned alongside the second chute 126 so that it can detect the passage of a pill in the second chute 126. The second chute 126 also engages the tray 128 such that a pill passing through the second chute 126 will be delivered into the tray 128.

In the first embodiment, the tamper resistance mechanism 130 is positioned within the hopper 121 and includes a fluid vessel 132, a tamper resistance fluid 133, and a rupture device 134. The tamper resistance fluid 133 is contained within the tamper resistance vessel 132, and may consist of a variety of fluids that would spoil or otherwise damage the pills upon exposure. Such fluids are known in the art, and include without limitation saline, food dye, black dye, and syrup of ipecac. It will be understood that the particular makeup of the tamper resistance fluid 133 may depend upon the particular makeup of the pills being used in the embodiment of the pill dispensing device 10. The fluid vessel 132 has a first surface 135 that engages the rupture device 134. The rupture device 134 is capable of rupturing the first surface 135 such that the tamper resistance fluid 133 will spill out of the fluid vessel 132 and engage the pills within the hopper 121, rendering such pills less functional or alternatively unusable. It will be understood that while FIG. 1 depicts the tamper resistance mechanism 130 engaged with the hopper 121, other configurations are possible. In an alternative embodiment, the tamper resistance mechanism 130 is attached to an underside 202 of the lid 200. Alternative tamper resistance mechanisms may include the use of heating elements or any other destructive means.

As depicted in FIGS. 1 and 2, the lid 200 of the pill dispensing device 10 includes a display 220, an RFID reader 230, a locking mechanism 240, a first wire 250 and a second wire 252. The display 220 is connected to the processing unit 300 and displays relevant information which may include the number of pills in the pill dispensing device 10, the amount of time left until a new pill can be dispensed, and other general information which may include the contact information regarding the pharmacy where the pill dispensing device 10 was obtained and/or personal information regarding the user of the pill dispensing device 10. It will be understood that the RFID reader 230 is also connected to the processing unit 300 and is configured to communicate with an RFID fob or other similar device.

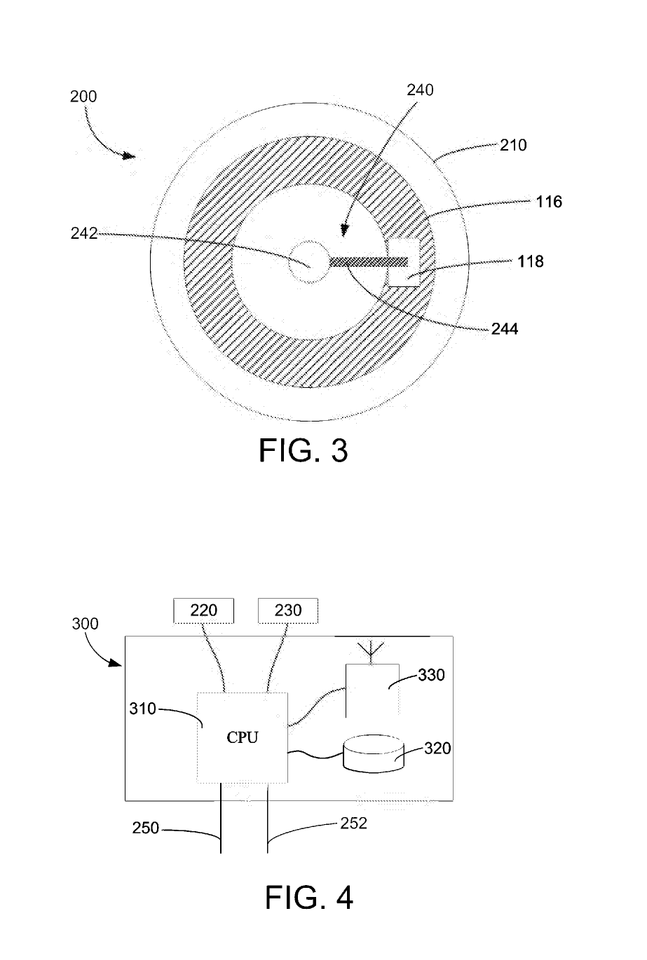

Turning to FIG. 3, depicted therein is a cross-sectional view of the interface between the container 100 and the lid 200 that particularly shows the locking mechanism 240 of the lid 200. As shown, the locking mechanism 240 includes a servo motor 242, and a locking pin 244. In the first embodiment, the servo motor 242 is centrally located on the bottom of the lid 200 and is connected to the processing unit 300 (not depicted in FIG. 3) and the locking pin 244. The locking pin 244 is selectively capable of being extended and retracted by the servo motor 242. When extended, the locking pin 244 fits into a recess 118 that is formed into the top ring 116 of the container 100. Notably, FIG. 3 shows the locking pin 244 in the extended position. In this position, the locking pin 244 prevents the disengagement of the lid 200 with the container 100, effectively locking the pill dispensing device 10, and preventing the extraction of pills from the container 100. It will be understood that alternative embodiments of the locking mechanism 240 are possible. In one alternative embodiment, the locking mechanism 240 includes of a plurality of locking pins 240, each of which fits in each of a plurality of recesses 118 formed into the top ring 116.

Turning back to FIG. 1, the first wire 250 and second wire 252 extend from the lid 200 into the space 113 between the first wall 112 and the second wall 113 of the container 100. The first wire 250 and second wire 252 are both configured to engage the conductive liquid 115. In the first embodiment show in FIG. 1, the first wire 250 is shorter than second wire 252.

Turning to FIG. 4, depicted therein is a schematic of the processing unit 300, which includes a CPU 310, a data store 320, and may include a communication module 330. It will be understood that these components can be either combined or divided into different physical components as desired. For example, the functions of the CPU 310 and the data store 320 could be combined into a single physical component, or the functions of the communications module 330 could be divided into several different physical components.

In the first embodiment, the communications module 330 is a universal serial bus port that will accepts a standard USB cable and is configured to communicate with a personal computer. It will be understood, however, that the communications module 330 may also support other communications protocols including wifi, bluetooth, etc., so long as the communications module 330 can communicate with a personal computer.

Now referring to FIGS. 1-4, the processing unit 300 is connected to the dispensing assembly 120, the tamper resistance mechanism 130, the display 220, the RFID reader 230, the locking mechanism 240, the first wire 250 and the second wire 252. In operation, the processing module 300 manages the various functions of the components of the pill dispensing device 10.

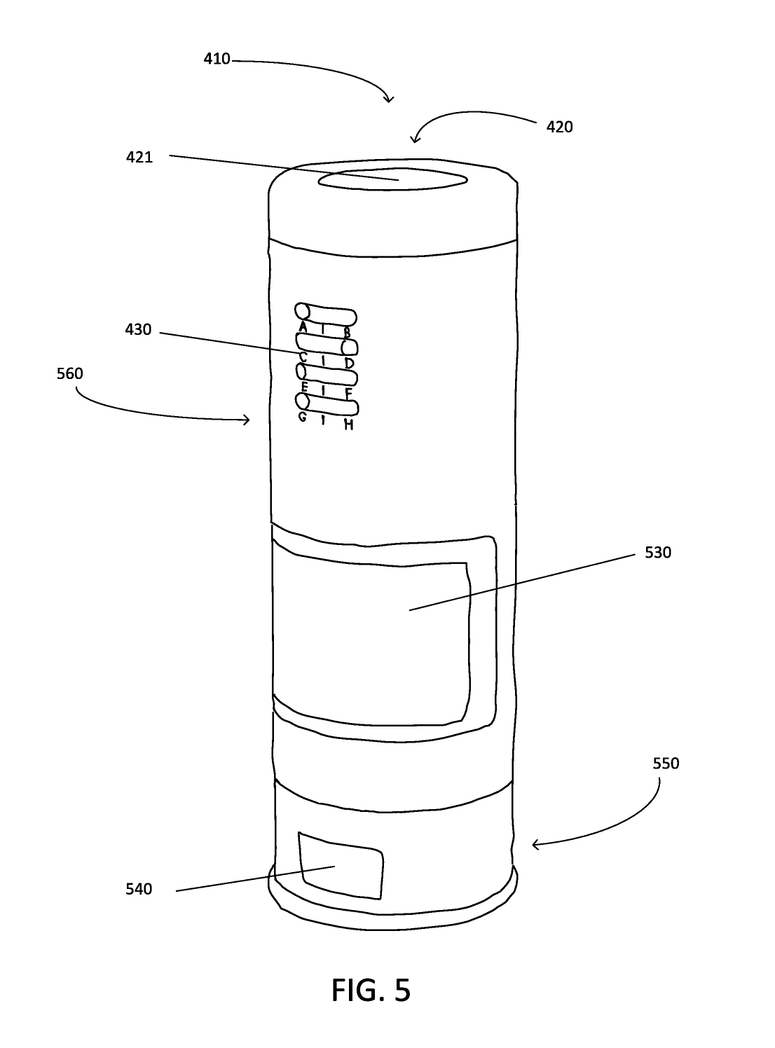

In a preferred second embodiment, FIG. 5 shows a side view of a pill dispensing device 410. The pill dispensing device 410 includes a lid 420 and a container 560. The lid 420 engages the container 560, via a servo lock, or alternatively the lid 420 and container 560 may be threadably engaged. The container 560 includes a locking mechanism 430, which allows the user to enter a code and receive a pill if certain parameters are met, and a label 530. As depicted in FIG. 5, the locking mechanism 430 uses a letter combination, but it will be understood that color or number combinations could replace the letter combination. While FIG. 5 depicts the label 530 as a metal-type material adhered to the side of the container 560, it will be understood that the label 530 may be made of any other type of material known in the art that is disposable and can be adhered to the side of the container 560. Such materials include, but are not limited to, paper and plastic. Alternatively, the label may be electronic, allowing the pharmacist to enter the desired information, such as user name, type of pills, the pharmacy name, the amount and timing pills may be dispensed, or other information regularly placed on the labels of pill bottles.

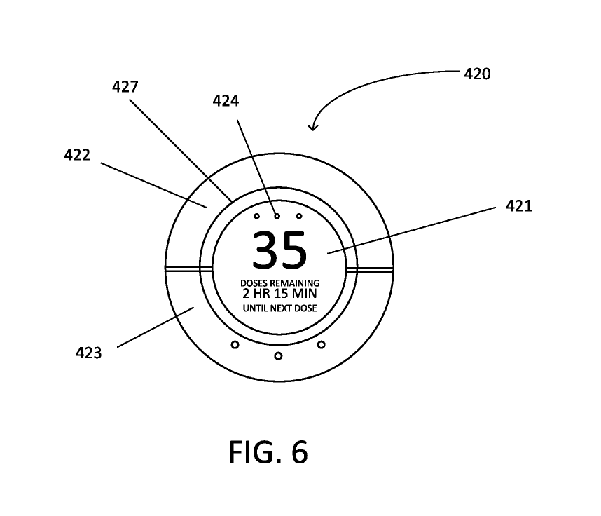

As shown in FIGS. 5 and 6, the lid 420 includes a lid screen 421, a first button 422, a second button 423, a plurality of LEDs 424, and LED ring 427. While the lid screen 421 in FIG. 6 displays the parameters of the time remaining until next dose and the number of pills remaining, the first button 422 and the second button 423 are configured to allow the user to toggle between different parameters and information, which will be displayed on the lid screen 421. The parameters and information may be different if the user is accessing the pill dispensing device 410 or if the pharmacist is accessing the pill dispensing device 410. The LEDs 424 are configured to display the power level of the rechargeable batteries of the pill dispensing device 410. The LEDs 424 may change colors or one or more LEDs 424 may shut off or turn on to indicate more or less battery life for the pill dispensing device 410. The LED ring 427 is configured to display all colors. Such color displays may indicate certain conditions with the pill dispensing device 410. For instance, a red LED ring 427 may indicate the pills have been destroyed by one of the methods described herein, or a green LED ring 427 may indicate that a pill is ready to be dispensed.

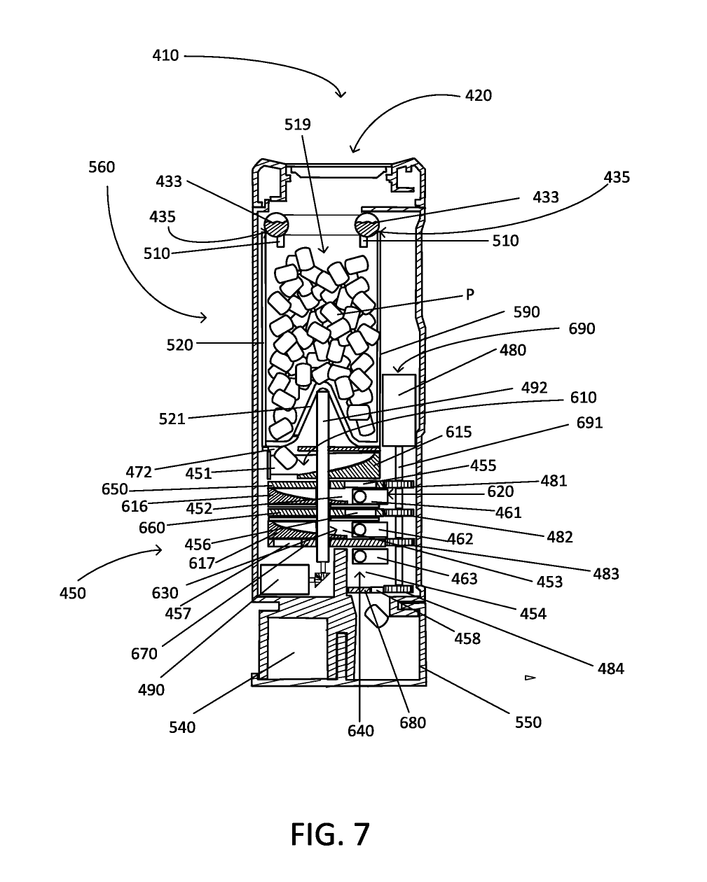

Turning to FIG. 7, shown therein is a side cross-sectional view of the pill dispensing device 410, which depicts the preferred internal structure of the container 560. The container 560 includes a hopper assembly 519 and a dispensing assembly 450. The hopper assembly 519 can hold a plurality of pills, which can be selectively released into the dispensing assembly 450, as further described below.

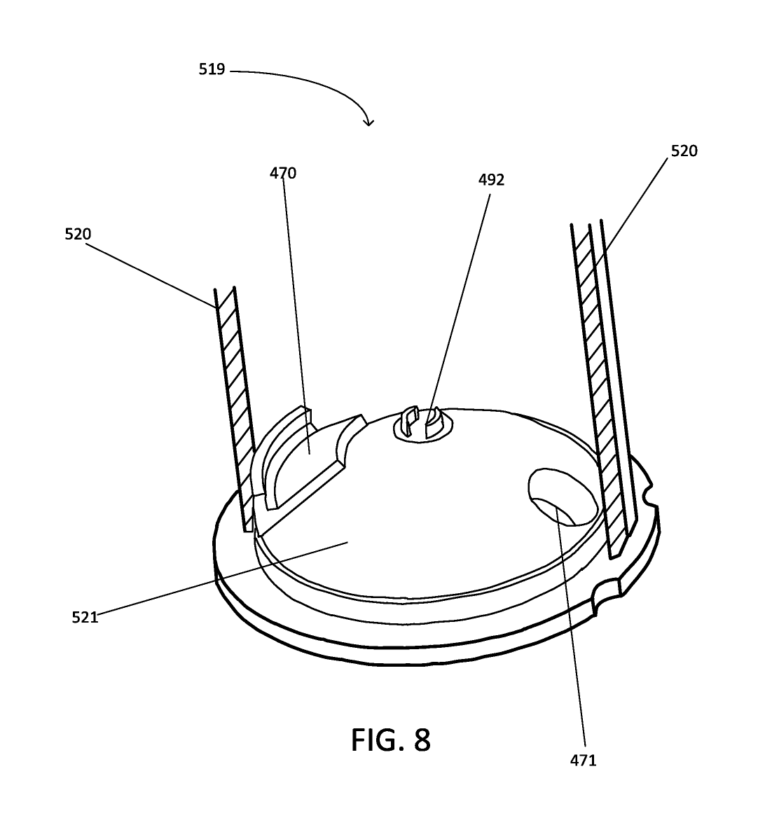

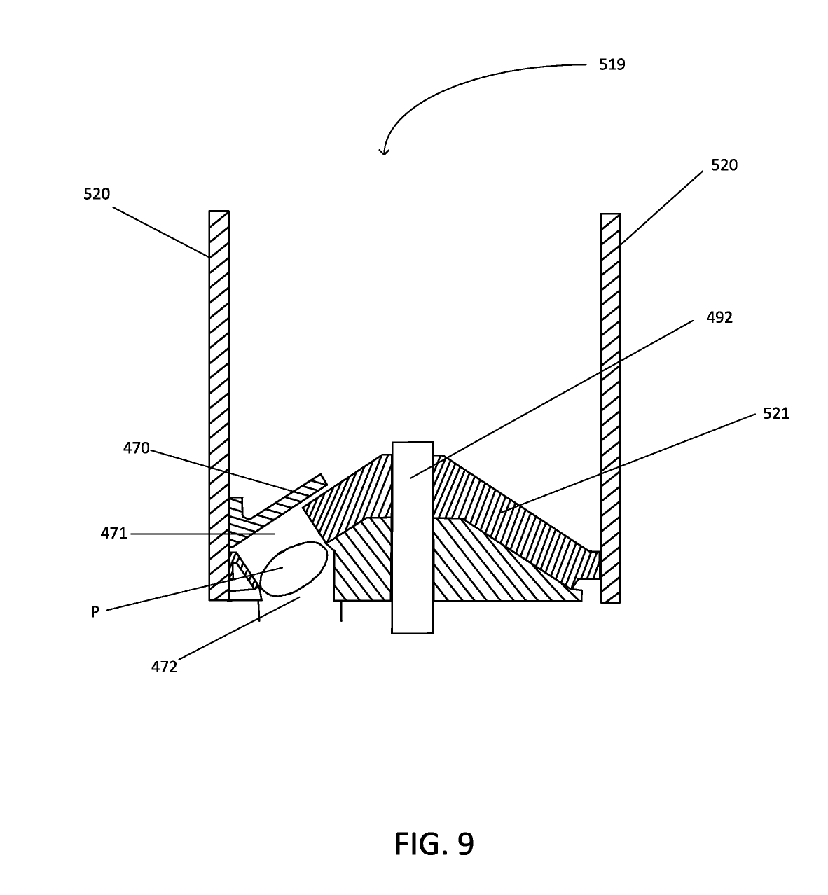

The hopper assembly 519 includes a hopper 520, a hopper carousel 521, a retention slot cover 470, a carousel motor 490, a carousel shaft 492, and a tamper resistance mechanism 435. As previously discussed, the hopper 520 is configured to hold a plurality of pills of varying shapes and sizes. The hopper 520 connects with the hopper carousel 521, as depicted in FIGS. 7-9. It will be understood that the hopper carousel 521 can have different shapes, such as a deep angle as shown in FIG. 7 or a more shallow angle as shown in FIGS. 8 and 9. A pill retention slot 471 is disposed within the hopper carousel 521. The precise shape and dimensions of the pill retention slot 471 will be determined based on the size and shape of the pills used in any given embodiment. It will be understood that the hopper carousels 521 can be removed and replaced with other hopper carousels 521 to accommodate the different sizes and shapes of pills. To help facilitate the movement of pills, the hopper carousel 521 engages the carousel shaft 492 which connects to the carousel motor 490.

Turning back to FIG. 7, the tamper resistance mechanism 435 is positioned within the hopper 520, and includes a tamper resistance fluid 433 and one or more jets 510. The tamper resistance fluid 433 is any type of fluid known in the art, which is capable of rendering the pills unusable. Such fluids include, but are not limited to, saline, food dye, black dye, and syrup of ipecac. While the current embodiment illustrates two tamper resistance mechanisms 435, in alternative embodiments one or more tamper resistance mechanisms 435 may be present. The one or more jets 510 are configured to release the tamper resistance fluid 433 from the tamper resistance mechanism 435 as described below. Alternative tamper resistance mechanisms 435 may include the use of heating elements or any means to render pills unusable.

The dispensing assembly 450 includes a first dispensing subassembly 610, a second dispensing subassembly 620, a third dispensing subassembly 630, a fourth dispensing subassembly 640, and a plate driving assembly 690. The first dispensing subassembly 610 includes a first plate 650 that has a first release 455, a hopper escape slide 472, a first chute 451, and a first chute funnel 615. The hopper escape slide 472 is configured facilitate the movement of pills from the pill retention slot 471 to the first chute 455. The first chute funnel 615 funnels the pill towards the first release 455. Upon certain parameters being met, the pill to move through the first release 455 of the first plate 650, as described below. A sensor can be added to the first dispensing subassembly 610 to detect the presence of a pill in the first chute 451.

The second dispensing subassembly 620 includes a second plate 660 that has a second release 456, a second chute 452, a second chute funnel 616, and a first sensor 461. The first sensor 461 is configured to determine if a pill is present in the second chute 452. If a pill is present in the second chute 452, and certain parameters are met, the pill may move through the second release 456 of the second plate 660, as described below. The second chute funnel 616 is configured to funnel the pill toward the second release 456 to help facilitate the movement of the pill.

The third dispensing subassembly 630 includes a third plate 670 that has a third release 457, a third chute 453, and a second sensor 462. The second sensor 462 is configured to determine if a pill is present in the third chute 453. If a pill is present in the third chute 453, and certain parameters are met, the pill may move through the third release 457 of the third plate 670, as described below. The third chute funnel 617 is configured to funnel the pill toward the third release 456 to help facilitate the movement of the pill.

The fourth dispensing subassembly 640 includes a fourth plate 680 that has a fourth release 458, a fourth chute 454, a third sensor 463, and a tray 550. The third sensor 463 is configured to determine if a pill is present in the fourth chute 454. If a pill is present in the fourth chute 453, and certain parameters are met, the pill may move through the fourth release 458 of the fourth plate 680 and into the tray 550 where the user can access the pill through window 540, as described below. It will be understood that the fourth plate 680 may be replaced by a gate, a wiper type attachment, a servo arm, or any other mechanism known in the art to allow that is capable of retaining a pill within the fourth chute 454 and then moving to release such pill, or the fourth plate 680 may be replaced by an aperture (if a fourth gear 484, as described below is not needed when the fourth plate 680 is replaced, it will be understood that fourth gear will be removed).

The plate driving assembly 690 includes a dispensing assembly motor 480, a dispensing assembly motor shaft 691, a first gear 481, a second gear 482, a third gear 483, and the fourth gear 484. The dispensing assembly motor 480 engages the dispensing motor shaft 691, which in turn rotates the first gear 481, the second gear 482, the third gear 483, and the fourth gear 484, as described below.

FIG. 8 shows the hopper assembly 519. The hopper assembly 519 includes a retention slot cover 470, a hopper 520, a hopper shaft 492, and a hopper carousel 521 that has a pill retention slot 471. The hopper carousel 521 is removable, allowing for hopper carousels 521 with different sized and shaped pill retention slots 471 to be inserted into the pill dispensing device 410, which allows the pill dispensing device 410 to accommodate all sizes and shapes of pills.

FIG. 9 shows the hopper 520. The hopper 520 includes retention a slot cover 470, a hopper shaft 492, a hopper 520, and a hopper carousel 521 that has a pill retention slot 471. As shown, a pill is leaving the hopper 520 through the pill retention slot 471, which is above the hopper escape slide 472 of the pill dispensing assembly 450.

It will be understood that a pharmacist must first setup the pill dispensing device 10 before it can be used by a patient. In the first embodiment the pharmacist must first open the pill dispensing device 10 by bringing an authorized RFID fob in proximity with the RFID reader 230. The RFID reader then signals the processing unit 300 that an authorized RFID fob has been used. The processing unit 300 will then signal the locking mechanism 240 to selectively change the position of the locking pin 244, which thereby either locks or unlocks the lid 200 from the container 100.

Turning back to the first embodiment, the pharmacist opens the pill dispensing 10 by plugging a USB cable into the communications module 330 thereby connecting with the personal computer. So long as the USB cable is plugged into the communications module 330, the locking mechanism 240 will maintain the locking pin 244 in an open position. As soon as the USB cable is removed from the communications module 330, the locking mechanism 240 will change the position of the locking pin 244 into a closed position. In a further aspect of this alternative embodiment, once the USB cable is connected to the communication module 330, an authentication code specific to the pharmacist's pharmacy is stored by the processing unit 300. Thereafter, the locking mechanism 240 cannot be disengaged unless the authentication code specific to the pharmacist's pharmacy is transmitted by the pharmacist over the USB cable to the communication module 330. It will be understood that this functionally “pairs” the pill dispensing device 10 with the pharmacists' pharmacy thereby preventing the user from using that pill dispensing device 10 with at a different pharmacy. Optionally, the pill dispensing device 10 can be configured to use encrypted code to allow only a particular computer at a pharmacy to open the pill dispensing device 10.

Once the lid 200 is removed from the container 100, the pharmacist fills the hopper 121 with the desired type and number of pills. The pharmacist then uses a personal computer to communicate with the processing unit 300 via the communications module 330. In particular, the pharmacist will indicate how often a pill can be dispensed, how many pills were loaded into the hopper 121, and a code identifying a patient RFID fob. In alternative embodiments, the pharmacist may indicate what type of pills were loaded into the hopper 121, whether any refills will be allowed, the patient's name and other related personal information. Such information is stored on the data store 320 as needed. Once the pharmacist has indicated all of the desired information, the lid 200 is engaged back onto the top ring 116 of the container 100, which is then locked by the locking mechanism 240, and the pill dispensing device 10 is given to the patient for use.

A patient operates the pill dispensing device 10 by placing a personal RFID fob in close proximity with the RFID reader 230. After detecting the patient's RFID fob, the RFID reader 230 will signal the processing unit 300 that the patient wishes to dispense one of the pills. The processing unit 300 will then evaluate the request against the information previously entered by the pharmacist. In particular, the processing unit 300 will determine if enough time has passed since the last pill was dispensed, and if this particular patient RFID fob is authorized. For example, if the pharmacist desires the particular type of pills in the pill dispensing device 10 to be used only once every 4 hours, then the processing unit 300 will determine whether 4 hours has passed since the last pill was dispensed. If 4 hours have not passed, then the processing unit 300 will signal the display 220 to display the amount of time left until a pill can be dispensed.

The first embodiment may also function through the processing unit 300 determining, based upon the information input by the pharmacist, that a pill can be dispensed, and then signaling the first trap door 122 to open so that a pill can move from the hopper 121 into the first chute 123. When a pill moves from the hopper 121 past the first trap door 122 into the first chute 123, the first sensor 124 signals the processing unit 300 that a pill is now in the first chute 123. The processing unit 300 will then signal the first trap door 122 to close, and then signal the second trap door 125 to open, thus preventing any more pills from moving into the first chute 123 and permitting the pill in the first chute 123 to move through the second chute 126 into the tray 128. As the pill passes through the second chute 126, the second sensor 127 signals the processing unit 300 and indicates that a pill has been dispensed into the tray 128. The processing unit 300 counts the number of pills of dispensed and stores that count in the data store 320. The number of dispensed pills can then be later communicated to the pharmacist via the communications module 330. After a pill is dispensed, the processing unit 300 then signals the second trap door 125 to close. The patient may then open the tray 128 and retrieve the dispensed pill.

It will therefore be understood that unauthorized users (those without an authorized patient RFID fob) are unable to dispense pills from the pill dispensing device 10. It will also be understood that even authorized users (those with an authorized patient RFID fob) can only dispense pills in accordance with the schedule indicated by the pharmacist when the pill dispensing device 10 was setup.

The pill dispensing device 10 is further secured through the operation of the tamper resistance mechanism 130. It will be understood that the processing unit 300 monitors the conductive liquid 113 by passing a current from the first wire 250 through the conductive liquid 113 to the second wire 252. It will be further understood that if a user attempts to tamper with the pill dispensing device 10 by breaking through the first cylinder 110 of the container 100, the conductive liquid 115 will spill through any rupture in the first wall 100 thus breaking the circuit between the first wire 250, the conductive liquid 115 and the second wire 252. Similarly, if a material capable of producing an electric current is used, a rupture in the first wall 100 will cause a detectable fluctuation in the electric current of the material. When the processing unit 300 detects that circuit break or fluctuation in the electric current, it signals the tamper resistance mechanism 130 to activate. As discussed above, activation of the tamper resistance mechanism 130 will result in rending the pills unusable. It will be understood that because the first wire 250 and second wire 252 are preferably of different lengths, the function of the tamper resistance mechanism 130 cannot be circumvented by tilting the pill dispensing device 10 upside down to ensure at the conductive liquid 115 maintains contact with the first wire 250 and second wire 252.

Turning back to the second embodiment, the pharmacist or medical professional opens the pill dispensing device 410 by connecting a computer to the pill dispensing device 410. If the pill dispensing device 410 recognizes the computer as a pharmacy computer through encrypted code, the servo lock will disengage, unlocking the lid 420. It will be understood that if encrypted code is not used to assist the pill dispensing device 410 in recognizing the computer, some other means known in the art for a device recognizing a computer will be used or the pharmacist will enter some type of code to unlock the lid 420, as described above. The pharmacist or medical professional can then remove the lid and put the number and type of pills desired in the pill dispensing device 410. When a new user or a new plurality of pills is assigned the pill dispensing device 410, the new information, such as the doctor that prescribed the pills, the number of pills, the type of pills, the schedule for taking pills, and/or the patient name can be entered onto label 530. Additionally, parameters may be entered by a pharmacist or medical provider, such as the timing of when a pill should be released from pill dispensing device 410 and the number of pills inside of the pill dispensing device 410 by connecting the pill dispensing device to a computer, as described above. Once programmed with the parameters, the lid screen 421 of lid 420 will display certain parameters (as discussed above, the first button 422 and the second button 423 allow the user to toggle between different parameters). Many of the parameters will update each time such parameters are met.

After the parameters are set and the pill dispensing device 410 is locked, the pill dispensing device 410 will use the first sensor 461, the second sensor 462, and the third sensor 463 to determine if pills are present in the second chute 452, the third chute 453, or the fourth chute 454. If pills are present and the pill dispensing device 410 has not taken any actions since being programmed, an error message will occur that requires the user to return to the location where the user received the pill dispensing device 410 to determine if the wrong pill is in a chute 452, 453, 454, or if the pill dispensing device 410 needs to be reprogrammed or replaced. If the first sensor 461, the second sensor 462, or the third sensor 463 does not detect a pill in a chute 452, 453, 454, then the pill dispensing device 410 will begin the process of placing a pill into chutes 461, 462, and 463.

The initial process of placing pills in the second chute 461, the third chute 462, and the fourth chute 463 occurs upon the first use of the pill dispensing device 410 by a user, or may be set to occur upon the pill dispensing device 410 being programmed by the pharmacist or medical provider. The pill dispensing device 410 will communicate, through a processing unit 300 (shown in FIG. 4 and described above) within the pill dispensing device 410, with the first sensor 461, the second sensor 462, and the third sensor 463. When the sensors 461, 462, 463 indicate to the pill dispensing device 410 that the second chute 452, the third chute 453, and the fourth chute 454 do not contain pills, the second motor 490 rotates the hopper shaft 492, which rotates the hopper carousel 521. A pill retention slot 471 in the hopper carousel 521 (as shown in FIGS. 8 and 9) either contains a pill that has fallen into the pill retention slot 471 or will receive a pill during the rotation of the hopper carousel 521. The retention slot cover 470 may also assist with a pill moving into the pill retention slot 471 because the retention slot cover 470 stays in place during the movement of hopper carousel 521, while the pill retention slot 471 rotates with the hopper carousel 521. The retention slot cover 470 also keeps more than one pill from sliding down the hopper escape slide 472. Once a pill moves into pill retention slot 471, it will continue to rotate with the hopper carousel 521 until it reaches hopper escape slide 472. Upon reaching the hopper escape slide 472 under the retention slot cover 470, the pill slides down the hopper escape slide 472 and into the first chute 451. The dispensing assembly motor 480 will then rotate the dispensing assembly motor shaft 691, which rotates the first gear 481, the second gear 482, the third gear 483, and the fourth gear 484 simultaneously, which will then respectively engage first plate 601, second plate 602, third plate 603, and fourth plate 604. The pill will then move through the first release 455 into the second chute 452. In the second chute 452, the first sensor 461 will detect the presence of the pill.

The pill dispensing device 410 will continue to detect through sensors 461, 462, 463 that the third chute 453 and the fourth chute 454 do not contain a pill. The second motor 490 then rotates the hopper shaft 492, which rotates hopper carousel 521. A pill retention slot 471 in the hopper carousel 521 (as shown in FIGS. 8 and 9) either contains a pill that has fallen into the pill retention slot 471 or will receive a pill during the rotation of the hopper carousel 521. The retention slot cover 470 may also assist with a pill moving into the pill retention slot 471 because the retention slot cover 470 remains stationary during the rotation of hopper carousel 521, while the pill retention slot 471 rotates with the hopper carousel 521. Once a pill moves into pill retention slot 471, it will continue to move with the hopper carousel 521 until it reaches hopper escape slide 472 under the retention slot cover 470. Upon reaching the hopper escape slide 472 under the retention slot cover 470, the pill slides down the hopper escape slide 472 and moves into the first chute 451. The dispensing assembly motor 480 will then rotate the dispensing assembly motor shaft 691, which will move the first gear 481, the second gear 482, the third gear 483, and the fourth gear 484 simultaneously, which will then respectively engage first plate 601, second plate 602, third plate 603, and fourth plate 604. The pill in the second chute 452 will then move through the second release 456 to the third chute 453, while the pill that retention slot cover 470 came from the hopper 520 will move through the first release 455 into the second chute 452.

The pill dispensing device 410 will continue to detect through sensors 461, 462, 463 that the fourth chute 454 does not contain a pill. The second motor 490 then rotates the hopper shaft 492, which rotates the hopper carousel 521. A pill retention slot 471 in the hopper carousel 521 (as shown in FIGS. 8 and 9) either contains a pill that has fallen into the pill retention slot 471 or will receive a pill during the rotation of the hopper carousel 521. The retention slot cover 470 may also assist with a pill moving into the pill retention slot 471 because the retention slot cover 470 stays in place during the movement of hopper carousel 521, while the pill retention slot 471 moves with the hopper carousel 521. Once a pill moves into pill retention slot 471, it will continue to move with the hopper carousel 521 until it reaches retention slot cover 470. Upon reaching retention slot cover 470, the pill slides down the hopper escape slide 472 and falls into first chute 451.The dispensing assembly motor 480 will then engage the dispensing assembly motor shaft 691, which rotates the first gear 481, the second gear 482, the third gear 483, and the fourth gear 484 simultaneously, which will then respectively engage first plate 601, second plate 602, third plate 603, and fourth plate 604. The pill in the third chute 453 will then move through the third release 457 into the fourth chute 454, the pill in the second chute 452 will then move through the second release 456 to the third chute 453, and the pill that retention slot cover 470 came from the hopper 520 will move through into the second chute 452.

Now, the pill dispensing device 410 will communicate with the first sensor 461, the second sensor 462, and the third sensor 463 to determine that pills are in the second chute 452, the third chute 453, and the fourth chute 454. Upon the time parameter being met, the second motor 490 engages hopper shaft gear 491, which moves rotates the hopper shaft 492, which causes the hopper carousel 521 to rotate. A pill retention slot 471 in the hopper carousel 521 (as shown in FIGS. 8 and 9) either contains a pill that has fallen into the pill retention slot 471 or will receive a pill during the rotation of the hopper carousel 521. The retention slot cover 470 may also assist with a pill moving into the pill retention slot 471 because the retention slot cover 470 stays in place during the movement of hopper carousel 521, while the pill retention slot 471 moves with the hopper carousel 521. Once a pill moves into pill retention slot 471, it will continue to move with the hopper carousel 521 until it reaches retention slot cover 470. Upon reaching retention slot cover 470, the pill falls into first chute 451. The dispensing assembly motor 480 will then rotate the dispensing assembly motor shaft 691, which rotates the first gear 481, the second gear 482, the third gear 483, and the fourth gear 484 simultaneously, which will then respectively engage first plate 601, second plate 602, third plate 603, and fourth plate 604. The pill in the fourth chute 484 will drop through the fourth release 458 into the tray 550, the pill in the third chute 453 will then move through the third release 457 into the fourth chute 454, the pill in the second chute 452 will then move through the second release 456 to the third chute 453, and the pill that retention slot cover 470 came from the hopper 520 will move through into the second chute 452. The user may now remove the pill from the tray 550 through window 540. This process will continue until the pill dispensing device is out of pills, unless the pill dispensing device is tampered with.

If the pill dispensing device 410 is tampered with, the tamper resistance mechanism 435 is ruptured. Methods for puncturing a pouch filled with fluid are known in the art and understood by persons of ordinary skill in the art. In this embodiment, the rupture occurs through heat being applied to the tamper resistance mechanism 435. In an alternative embodiment, a servo and a blade may rupture the tamper resistance mechanism 435. Upon the rupturing of the tamper resistance mechanism 435, the tamper resistance fluid 433 is released onto the pills through jets 510 rendering the pills unusable, either through their destruction or through other known means that renders the pills inoperable for their intended purpose.

Should the hopper assembly 519 fail or experience a jam, the pills in chutes 452, 453, and 454 will continue to be dispensed normally, allowing the user to receive medications until the pill dispensing device can be taken into the pharmacy for repair or replacement.

It is clear that the present invention is well adapted to carry out its objectives and attain the ends and advantages mentioned above as well as those inherent therein. While two embodiments of the invention have been described, it will be understood that the elements and alternative elements of either embodiment may replace the elements of the other embodiment, or be used in conjunction with the other elements and alternative elements of the other embodiment. Additionally, certain embodiments of the invention have been described in varying detail for purposes of disclosure, but it will be understood that numerous changes may be made which will readily suggest themselves to those skilled in the art and which are encompassed within the spirit of the invention disclosed, as defined in the written description and appended claims.

I claim:

1. A pill dispenser, comprising:
a lid having a RFID reader;
a container, engaged with the lid and comprising:
a hopper assembly comprising:
a hopper configured to hold a plurality of pills; and
a hopper carousel positioned within the hopper, the hopper carousel configured to selectively release a pill from the plurality of pills from the hopper when an authorized RFID is read by the RFID reader; and
a dispensing assembly engaged with the hopper assembly, the dispensing assembly comprising:
a first chute configured to receive the released pill from the hopper carousel;
a first plate positioned beneath the first chute and having a first release, the first release configured to receive the released pill from the first chute;
a second chute engaging the first release and configured to receive the released pill from the first release;
a second plate positioned beneath the second chute and having a second release, the second release configured to receive the released pill from the second chute; and
a tray positioned beneath the second release and configured to receive the released pill from the second release and to dispense the released pill.

2. (canceled)

3. (canceled)

4. The pill dispenser of claim 1, the container further comprising a tamper resistant mechanism positioned within the hopper assembly, wherein the tamper resistant mechanism comprises:
a tamper resistant fluid; and
one or more jets configured to dispense the tamper resistant fluid into the hopper assembly.

5. The pill dispenser of claim 4, wherein the tamper resistance mechanism is configured to render the plurality of pills in the hopper unusable when the tamper resistant fluid is dispensed into the hopper assembly.

6. The pill dispenser of claim 1 further comprising a processing unit configured to store a time period that must pass between the release of each one of the pills in the plurality of pills and to prevent the release of any one of the pills in the plurality of pills more than once during the time period.

7. (canceled)

8. A pill dispenser, comprising:
a lid;
a container, engaged with the lid and comprising:
a hopper configured to hold a plurality of pills; and
a dispensing assembly configured to retain one or more pills;
wherein the container is configured to dispense pills out of the hopper and into the dispensing assembly when a parameter is met; and
a tray, wherein the tray is configured to receive a pill from the dispensing assembly.

9. The pill dispenser of claim 8, wherein the container further comprises a tamper resistance mechanism, wherein the tamper resistance mechanism is configured to render the plurality of pills in the hopper unusable.

10. The pill dispenser of claim 9, the container further comprising:
a digital label, wherein the digital label displays the user's name; and
a code pad, wherein the code pad is used to selectively lock and unlock the lid.

11. The pill dispenser of claim 10, wherein the dispensing assembly further comprises:
a chute positioned beneath the hopper; and
a sensor configured to detect the presence of a pill in the chute.

12. The pill dispenser of claim 11, wherein the dispensing assembly further comprises:
a second chute positioned beneath the first chute; and
a second sensor configured to detect the presence of a pill in the second chute.

13. The pill dispenser of claim 12, wherein the dispensing assembly further comprises:
a third chute positioned beneath the second chute; and
a third sensor configured to detect the presence of a pill in the third chute.

14. A pill dispenser, comprising:
a lid; and
a container, engaging the lid, the container comprising:
a hopper configured to hold a plurality of pills; and
a tamper resistance mechanism configured to render the plurality of pills in the hopper unusable.

15. The pill dispenser of claim 14, wherein the tamper resistance mechanism uses ipecac to render the plurality of pills in the hopper unusable.

16. The pill dispenser of claim 14, wherein the tamper resistance mechanism uses saline to render the plurality of pills in the hopper unusable.

17. The pill dispenser of claim 14, wherein the tamper resistance mechanism uses black dye to render the plurality of pills in the hopper unusable.

18. The pill dispenser of claim 14, wherein the tamper resistance mechanism uses least two items selected from the following group to render the plurality of pills in the hopper unusable: ipecac, saline, black dye.

19. The pill dispenser of claim 14, wherein the tamper resistance mechanism is configured to rupture.

20. The pill dispenser of claim 1, the dispensing assembly further comprising a first sensor connected to the first chute.

21. The pill dispenser of claim 20, the dispensing assembly further comprising a second sensor connected to the second chute.

22. The pill dispenser of claim 21, the dispensing assembly further comprising:
a third chute positioned beneath the second release and having a third release the third release configured to receive the released pill from the third chute; and
a third sensor connected to the third chute.

23. The pill dispenser of claim 22, the dispensing assembly further comprising:
a fourth chute positioned beneath the third release and having a fourth release, the fourth release configured to receive the released pill from the fourth chute; and
a fourth sensor connected to the fourth chute.

24. The pill dispenser of claim 23, wherein the first sensor is capable of detecting pills retained in the first chute, the second sensor is capable of detecting pills retained in the second chute, the third sensor is capable of detecting pills retained in the third chute, and the fourth sensor is capable of detecting pills retained in the fourth chute.

25. The pill dispenser of claim 23, wherein the wherein the first sensor is capable of detecting pills traveling through the first chute, the second sensor is capable of detecting pills traveling through the second chute, the third sensor is capable of detecting pills traveling through the third chute, and the fourth sensor is capable of detecting pills traveling through the fourth chute.

26. The pill dispenser of claim 23, wherein the container is configured to release one of the plurality of pills out of the hopper assembly when a parameter is met.

27. The pill dispenser of claim 23, wherein the dispensing assembly is configured to release pills retained in the second chute, the third chute, and the fourth chute if the pill dispenser experiences a malfunction.
